(19) United States
(12) Patent Application Publication
(10) Pub. No.: US 2025/0386299 A1
(43) Pub. Date: Dec. 18, 2025

(54) ENHANCEMENTS ON POWER ALLOCATION

(71) Applicant: Nokia Technologies Oy, Espoo (FI)

(72) Inventors: Matha DEGHEL, Massy (FR); Keeth Saliya Jayasinghe LADDU, Espoo (FI)

(21) Appl. No.: 18/879,160

(22) PCT Filed: Jul. 13, 2022
(86) PCT No.: PCT/EP2022/069653

§ 371 Date: Dec. 26, 2024

(51) Int. Cl. H04W 52/14; H04W 72/0446; H04W 74/0833

(52) U.S. Cl. CPC H04W 52/146; H04W 72/0446; H04W 74/0833

(57) ABSTRACT

Example embodiments of the present disclosure relate to devices, methods, apparatuses and computer readable storage media for power allocation. The method comprises: in accordance with a determination that a total transmission power of a plurality of uplink transmissions comprising a first set of simultaneous transmissions exceeds a threshold of transmission power, allocating, at a terminal device, power to the plurality of uplink transmissions based on a priority order related to the first set of simultaneous transmissions, wherein the first set of simultaneous transmissions is on a cell and comprises at least a first transmission and a second transmission overlapping at least partly in time domain; and transmitting, to a network device, at least a part of the plurality of uplink transmissions. In this way, the performance of UL transmission operation can be improved.

### FIELD

Embodiments of the present disclosure generally relate to the field of telecommunication and in particular, to devices, methods, apparatus and computer readable storage media for powerallocation.

### BACKGROUND

With the development of Multiple Input Multiple Output (MIMO), simultaneous uplink transmission schemes have been proposed for higher uplink (UL) throughput and reliability. In such schemes, the simultaneous UL transmissions from multiple UE panels are scheduled by a single downlink control information (DCI). In addition to the parallel UL transmissions across cells, the UE is allowed to simultaneously transmit UL transmissions in the same cell. However, the total transmission power for UL transmissions on serving cells in a frequency range in a respective transmission occasion would not exceed a maximum UE transmission power. Thus, there is a need for enhancements in terms of power allocation and reduction.

### SUMMARY

In general, example embodiments of the present disclosure provide a solution of prioritization for transmission power allocation and reduction.

In a first aspect, there is provided an apparatus. The apparatus comprises at least one processor; and at least one memory including computer program codes; the at least one memory and the computer program codes are configured to, with the at least one processor, cause the apparatus at least to: in accordance with a determination that a total transmission power of a plurality of uplink transmissions comprising a first set of simultaneous transmissions exceeds a threshold of transmission power, allocate power to the plurality of uplink transmissions based on a priority order related to the first set of simultaneous transmissions, wherein the first set of simultaneous transmissions is on a cell and comprises at least a first transmission and a second transmission overlapping at least partly in time domain; and transmit, to a network device, at least a part of the plurality of uplink transmissions.

In a second aspect, there is provided an apparatus. The apparatus comprises at least one processor; and at least one memory including computer program codes; the at least one memory and the computer program codes are configured to, with the at least one processor, cause the apparatus at least to: transmit, to a terminal device, an indication indicating a priority order related to a first set of simultaneous transmissions on a cell via at least one of a radio resource control, RRC, message, or a medium access control control element, MAC CE or a downlink control information, DCI, wherein the first set of simultaneous transmissions comprises at least a first transmission and a second transmission overlapping at least partly in time domain; and receive, from the terminal device, at least a part of a plurality of uplink transmissions comprising the first set of simultaneous transmissions, the at least a part of uplink transmissions being transmitted with power allocated based on the priority order.

In a third aspect, there is provided a method. The method comprises: in accordance with a determination that a total transmission power of a plurality of uplink transmissions comprising a first set of simultaneous transmissions exceeds a threshold of transmission power, allocating, at a terminal device, power to the plurality of uplink transmissions based on a priority order related to the first set of simultaneous transmissions, wherein the first set of simultaneous transmissions is on a cell and comprises at least a first transmission and a second transmission overlapping at least partly in time domain; and transmitting, to a network device, at least a part of the plurality of uplink transmissions.

In a fourth aspect, there is provided a method. The method comprises: transmitting, at a network device and to a terminal device, an indication indicating a priority order related to a first set of simultaneous transmissions on a cell via at least one of a radio resource control, RRC, message, or a medium access control control element, MAC CE or a downlink control information, DCI, wherein the first set of simultaneous transmissions comprises at least a first transmission and a second transmission overlapping at least partly in time domain; and receiving, from the terminal device, at least a part of a plurality of uplink transmissions comprising the first set of simultaneous transmissions, the at least a part of uplink transmissions being transmitted with power allocated based on the priority order.

In a fifth aspect, there is provided an apparatus. The apparatus comprises: means for in accordance with a determination that a total transmission power of a plurality of uplink transmissions comprising a first set of simultaneous transmissions exceeds a threshold of transmission power, allocating power to the plurality of uplink transmissions based on a priority order related to the first set of simultaneous transmissions, wherein the first set of simultaneous transmissions is on a cell and comprises at least a first transmission and a second transmission overlapping at least partly in time domain; and means for transmitting, to a network device, at least a part of the plurality of uplink transmissions.

In a sixth aspect, there is provided an apparatus. The apparatus comprises: means for transmitting, to a terminal device, an indication indicating a priority order related to a first set of simultaneous transmissions on a cell via at least one of a radio resource control, RRC, message, or a medium access control control element, MAC CE or a downlink control information, DCI, wherein the first set of simultaneous transmissions comprises at least a first transmission and a second transmission overlapping at least partly in time domain; and means for receiving, from the terminal device, at least a part of a plurality of uplink transmissions comprising the first set of simultaneous transmissions, the at least a part of uplink transmissions being transmitted with power allocated based on the priority order.

In a seventh aspect, there is provided a computer readable medium having a computer program stored thereon which, when executed by at least one processor of a device, causes the device to carry out the method according to the third aspect.

In an eighth aspect, there is provided a computer readable medium having a computer program stored thereon which, when executed by at least one processor of a device, causes the device to carry out the method according to the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example network system in which example embodiments of the present disclosure can be implemented;

FIG. 2 shows a signaling chart illustrating an example procedure for transmission power control according to some example embodiments of the present disclosure;

FIG. 3 shows a schematic diagram of an example of UL transmissions for multiple serving cells according to some example embodiments of the present disclosure;

FIG. 4 shows a schematic diagram of another example of UL transmissions for multiple serving cells according to some example embodiments of the present disclosure;

FIG. 5 illustrates a flowchart of an example method according to some example embodiments of the present disclosure;

FIG. 6 illustrates a flowchart of another example method according to some example embodiments of the present disclosure;

FIG. 7 shows a simplified block diagram of a device that is suitable for implementing example embodiments of the present disclosure; and

FIG. 8 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

In the traditional communication system, for single cell operation with two UL carriers or for operation with carrier aggregation (CA), in case where a total UE transmit power for UL transmissions (e.g., PUSCH or PUCCH or PRACH or SRS transmissions) on serving cells in a frequency range in a respective transmission occasion i exceeds \hat{P}_{CMAX}(i), where \hat{P}_{CMAX}(i) denotes a linear value of the maximum transmission power \hat{P}_{CMAX}(i) in the transmission occasion i for FR1 and FR2, the UE allocates power to the UL transmissions according to a predetermined priority order so that the total UE transmit power is smaller than or equal to \hat{P}_{CMAX}(i) for that frequency range in every symbol of transmission occasion i.

As the MIMO has been enhanced in terms of simultaneous UL transmission from multiple panels, where two PUCCHs or two PUSCHs can be simultaneously transmitted in a cell, transmission power control rules would need to be designed in account for simultaneous UL transmission operations. In addition to the impact on across cells prioritization of power reductions, there may also be a need to define prioritization within a cell for the simultaneous UL transmissions.

In order to solve the above and other potential problems, embodiments of the present disclosure provide a power control scheme. The scheme concerns the prioritization of transmission power allocation and reduction for simultaneous UL transmissions in a single serving cell and parallel UL transmissions across multiple serving cells. In particular, the power control for simultaneous UL transmissions from multiple panels is realized by allocating transmission powers in order of power allocation priorities of respective UL transmissions. As a result, the performance of UL transmission operation is improved.

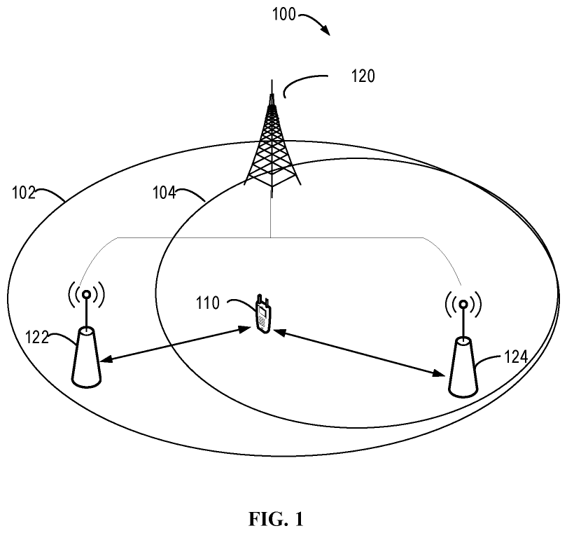

FIG. 1 illustrates an example network system 100 in which example embodiments of the present disclosure can be implemented. As shown in FIG. 1, the communication network 100 may include a terminal device 110, and a network device 120. The network device 120 is associated with or may comprise or may consist of at least two transmission reception points (TRPs) 122 and 124, where the serving cell 102 is configured with both of TRPs 122 and 124, and the serving cell 104 is configured with the TRP 124.

The network system 100 may be a multi-TRP system. The terminal device 110 may operate with multiple UL carriers, or with carrier aggregation (CA). In case of CA, the serving cell 102 may be also referred to as a primary cell or PCell, and the serving cell 104 may be also referred to as a secondary cell or SCell. In some embodiments, the network device 120 consists of one or both of TRPs 122 and 124. Alternatively, in other embodiments, the network device 120 is separate from and manages the TRPs 122 and 124.

The terminal device 110 supports simultaneous transmissions, such as, simultaneous PUCCH (Physical Uplink Control Channel) transmissions, PUSCH (Physical Uplink Shared Channel) transmissions, across multiple panels, and the simultaneous transmissions is scheduled by a single DCI. In the context of the present disclosure, the term “the simultaneous transmissions” refers to at least two PUCCH transmissions or at least two PUSCH transmissions transmitted on the same (serving) cell. The simultaneous UL transmissions may be transmitted based on the space division multiplexing (SDM), frequency division multiplexing (FDM), or single-frequency network (SFN) scheme. For purpose of discussion, various schemes are briefly described as below.
In the SDM scheme, different layers or DMRS ports of one PUSCH are separately pre-coded and transmitted from different UE panels simultaneously.
In the FDM-A scheme, different parts of the frequency domain resource of one PUSCH transmission occasion are transmitted from different UE panels.
In the FDM-B scheme: two PUSCH transmission occasions with same or different RV of the same transport block (TB) are transmitted from different UE panels on non-overlapped frequency domain resources and the same time domain resources.
In the SFN-based transmission scheme: all of the same layers or DMRS ports of one PUSCH are transmitted from two different UE panels simultaneously.
In the SDM repetition scheme, two PUSCH transmission occasions with different RV of the same TB are transmitted from two different UE panels simultaneously.

In the context of the present disclosure, the terms UL beam, spatial relation information, UL transmission configuration indicator (TCI) state, joint or common TCI state, spatial filter, power control information, power control parameters set, UE panel or panel ID, quasi-colocation information Type-D (or any other type, such as type A, B or C) may be interchangeably used. A UE panel may be identified by an index of UE capability value set or by a panel ID. Alternatively, or additionally, a panel may be identified or associated by at least one reference signal (RS) or simply by an UL beam.

It is to be understood that the number of network devices, the TRPs and the terminal device shown in FIG. 1 is given for the purpose of illustration without suggesting any limitations. The communication network 100 may include any suitable number of network devices and terminal devices.

Depending on the communication technologies, the communication network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

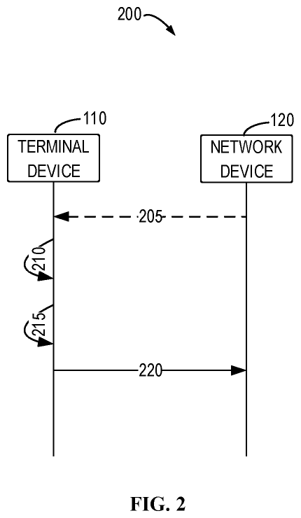

Principle and implementations of the present disclosure will be described in detail below with reference to FIGS. 2 to 6. FIG. 2 shows a signaling chart illustrating an example procedure 200 for transmission power control according to some example embodiments of the present disclosure. The process 200 may involve the terminal device 110 and the network device 120 as shown in FIG. 1. For discussion, the process 200 will be described with reference to FIG. 1.

In process 200, the terminal device 110 is able to operate with simultaneous multi-panel UL transmission on either one or both of the cell 102 and 104. In some example embodiments, the terminal device 110 may attempt to transmit a plurality of UL transmissions that overlap at least partly in time domain. Each of the plurality of UL transmissions may be associated with a respective priority index.

In some example embodiments, the network device 120 may transmit (205) an indication indicating a priority order related to a first set of simultaneous transmissions on the cell 102 via at least one of a RRC message, or a MAC CE or a DCI. The first set of simultaneous transmissions comprises at least a first transmission and a second transmission overlapping at least partly in time domain. In some other embodiments, such a priority order related to the first set of simultaneous transmissions may be predefined or specified for both of the terminal device 110 and the network device 120. Hence, step 205 is optional for the process 200.

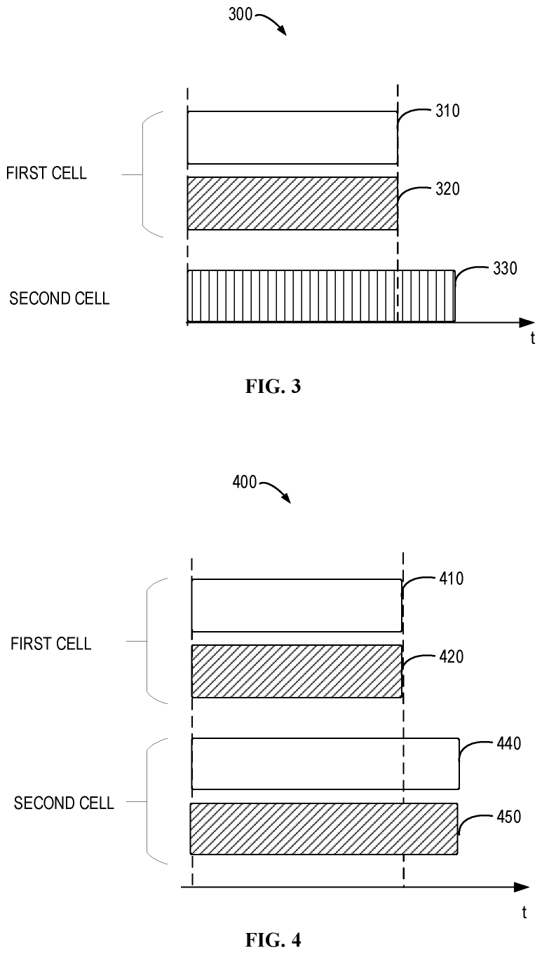

FIGS. 3 and 4 shows examples of UL transmissions for multiple serving cells according to some example embodiments of the present disclosure. As shown in FIG. 3, a first set of simultaneous UL transmissions includes a first transmission 310 and a second transmission 320, which are scheduled by a single DCI on the cell 102. The cell 102 may be configured with multiple resource sets, such as, SRS resource sets, CORESETs, and so on. Additionally, a third transmission 330 is scheduled by another DCI on the cell 104. The first set of simultaneous UL transmissions 310 and 320 and the third transmission 330 overlap at least partly in time domain.

As shown in FIG. 4, the first set of simultaneous UL transmissions includes the first transmission 410 and the second transmission 420, which are scheduled by a first DCI on the cell 102. Additionally, the second set of simultaneous UL transmissions includes a fourth transmission 440 and a fifth transmission 450, which are scheduled by a second DCI on the cell 104. The cells 102 and 104 may be configured with multiple resource sets. The first set of simultaneous UL transmissions 410 and 420 and the second set of simultaneous UL transmissions 440 and 450 overlap at least partly in time domain.

Prior to transmitting a plurality of UL transmissions, the terminal device 110 determines 210 if a total transmission power of the plurality of UL transmissions exceeds a threshold of transmission power. By way of example, the threshold of transmission power may be defined as \hat{P}_{CMAX}(i).

As mentioned above, the total transmission power shall be controlled below the threshold of transmission power. If the total transmission power is determined to exceed the threshold of transmission power in a transmission occasion, the terminal device 110 allocates 215 power to the plurality of UL transmissions based on the priority order related to the first set of simultaneous transmissions. In the context of the present disclosure, the transmission occasion may comprise a number of consecutive symbols within a slot or across slots.

In some example embodiments, the priority order may indicate prioritization in terms of transmission power allocation and/or transmission power reduction.

The terminal device 110 transmits 220 at least a part of the plurality of UL transmissions to the network device 120. The transmission powers of the plurality of UL transmissions are allocated based on the respective power allocation priorities, so that the total transmission power of the at least a part of the plurality of UL transmissions is below the threshold of transmission power.

The transmission powers may be allocated in a descending order of the respective power priorities of the plurality of UL transmissions, until the total transmission power reaches the threshold of transmission power. Accordingly, in some embodiments, upon the total transmission power reaches the threshold of transmission power, the terminal device 110 may drop a rest of the plurality of UL transmissions that is allocated with no transmission power. Additionally, or alternatively, in some embodiments, a part of the plurality of UL transmissions may be allocated with a reduced transmission power.

In some embodiments, the respective power priorities may be determined based on priority indexes of the plurality of the UL transmissions. For the purpose of determining the prioritizations of transmission power allocation, in some embodiments, simultaneous PUCCH or PUSCH transmissions with a higher priority index are defined to have at least one step/level higher priority than PUCCH or PUSCH transmissions associated with the same higher priority index. Additionally, or alternatively, in some embodiments, the simultaneous PUCCH or PUSCH transmissions with a higher priority index may have at least one step/level lower priority than the PRACH transmission on the primary cell.

In the example shown in FIG. 3, if the first set of simultaneous transmissions 310 and 320 and the third transmission 330 are associated with a same priority index, the terminal device 110 may assign a higher power allocation priority to the first set of simultaneous transmissions 310 and 320 than the third transmission 330. Additionally, or alternatively, the first set of simultaneous transmissions 310 and 320 may be assigned a lowered power allocation priority than the PRACH transmission on the primary cell of the terminal device 110.

In case of CA, the terminal device 110 may prioritize the power allocation for the UL transmissions on a cell with simultaneous UL transmissions, which include but not limited to, simultaneous PUCCH or PUSCH or PRACH or SRS transmissions. In other words, for the example shown in FIG. 3, the cell 102 that is with simultaneous UL transmissions 310 and 320 may be considered with a higher priority than the cell 104 without simultaneous UL transmissions.

In some embodiments, for the example shown in FIG. 3, the network device 120 manages the primary cell (i.e., the cell 102) and a secondary cell without simultaneous transmissions, i.e., the third transmission 330 on the cell 104. If the first set of simultaneous transmissions 310 and 320 and the third transmission 330 are assigned with a same power allocation priority, the terminal device 110 may prioritize a transmission power allocation for the first set of simultaneous transmissions 310 and 320 over the third transmission 330. The first set of simultaneous transmissions 310 and 320 may include at least one of simultaneous PUCCH transmissions, simultaneous PUSCH transmissions, simultaneous PRACH transmissions or SRS transmissions.

In a case where simultaneous PUCCH or PUSCH transmissions are not associated with a higher priority index, the simultaneous PUCCH or PUSCH transmissions may be assigned with a higher power allocation priority than any PUCCH or PUSCH transmission with the same priority index. As shown in FIG. 3, in some embodiments where the first set of simultaneous transmissions 310 and 320 and the third transmissions 330 are associated with the same priority index, the terminal device 110 may assign a higher power allocation priority to the first set of simultaneous transmissions 310 and 320 than the third transmissions 330.

For simultaneous PUCCH or PUSCH transmissions with same priority index, different levels of power allocation priority may be assigned by considering the content or use of the PUCCH/PUSCH, for example, aspects related to Hybrid Automatic Repeat request (HARQ), scheduling request (SR), link recovery request (LRR), Channel State Information (CSI), etc.

For the scenario 400 as shown in FIG. 4, the plurality of UL transmissions of the terminal device 110 includes the first set of simultaneous transmissions 410 and 420 on the cell 102, and the second set of simultaneous transmissions 440 and 450 on the cell 104. If the first set of simultaneous transmissions 410 and 420 and the second set of simultaneous transmissions 440 and 450 are associated with a same priority index, the terminal device 110 may determine the respective power allocation priorities based on contents of the first set of simultaneous transmissions and the second set of simultaneous transmissions.

In some example embodiments, levels of power allocation priority may be assigned in the following descending order, that is, higher priority listed first:
simultaneous PUCCH transmissions with at least one of Hybrid Automatic Repeat request—Acknowledge (HARQ-ACK) information, scheduling request (SR), link recovery request (LRR), or simultaneous PUSCH transmissions with HARQ-ACK information;
simultaneous PUCCH transmissions with CSI or simultaneous PUSCH transmissions with CSI;
simultaneous PUSCH transmissions without HARQ-ACK information or CSI, or simultaneous PUSCH transmissions on the primary cell (e.g., for Type-2 random access procedure).

For simultaneous UL transmissions within a single cell, the terminal device 110 may be configured (e.g., via RRC) or indicated (e.g., using existing or new fields/bits in a DCI and/or a MAC CE) or specified for the prioritization of the power allocation/reduction.

In the scenario 300 as shown in FIG. 3, the cell 102 is configured with a first resource set and a second resource set, and the terminal device 110 may prioritize a transmission power allocation for one of the first and second transmissions 310 and 320 that corresponds to the first resource set over the other one of the first and second transmissions 310 and 320 that corresponds to the second resource set. The index of the first resource set may be higher or lower than the index of the second resource set, and whether to prioritize the UL transmission associated with a higher resource set index or a lower resource set index may be predefined or specified. Alternatively, the terminal device 110 may prioritize the UL transmission associated with a given resource set index, and an indication indicating the given resource set index may be received via at least one of a RRC message, or a MAC CE or a DCI.

In a case where the first resource set and the second resource set may be CORESETs, the terminal device 110 may prioritize the UL transmission corresponding to a given CORESETPoolIndex. Additionally, or alternatively, in some example embodiments, the terminal device 110 may prioritize the UL transmission corresponding to a relatively lower CORESETPoolIndex or alternatively, to a relatively higher CORESETPoolIndex.

In a case where the first resource set and the second resource set may be SRS resource sets, the terminal device 110 may prioritize the UL transmission corresponding to a given SRS resource set. Additionally, or alternatively, in some example embodiments, the terminal device 110 may prioritize the UL transmission corresponding to the SRS resource set with a relatively higher index, or alternatively, with a relatively lower index.

Alternatively, in some embodiments, the terminal device 110 may prioritize the UL transmission corresponding to a given closed-loop (or at least one closed-loop parameter) or, alternatively, a given open-loop index (or at least one open-loop parameter) for power control. In some cases, the given closed-loop or given open-loop index (or the at least one corresponding parameter) for which the corresponding UL transmission to prioritize may be indicated, via DCI or MAC CE, or configured (e.g., via RRC) for the terminal device 110.

For the scenario 300 as shown in FIG. 3, in some example embodiments, the terminal device 110 prioritizes the transmission power allocation for one of the first and second transmissions 310 and 320 that is associated with a first cell identity (e.g., physical cell identity (PCI)) over the other one of the first and second transmissions that is associated with a second cell identity (e.g., PCI), and the first cell identity is higher or lower than the second cell identity. In this case, whether to prioritize the UL transmission with a higher PCI or a lower PCI may be predefined or specified. In some cases, the terminal device 110 may prioritize the UL transmission associated with a given PCI (e.g., the one provided in physical cell identity or ID), and an indication indicating the given PCI may be received via at least one of a RRC message, or a MAC CE or a DCI.

In some example embodiments, the terminal device 110 may prioritize a transmission power allocation for one of the first and second transmissions 310 and 320 over the other one based on a configuration locally stored at the terminal device. Alternatively, in some other embodiments, the terminal device 110 prioritizes a transmission power allocation for one of the first and second transmissions 310 and 320 over the other one based on an indication from the network device 120. The indication may be, for example, carried in existing or reserved or new fields/bits in a DCI or a MAC CE.

In some example embodiments, the terminal device 110 may prioritize a transmission power allocation for one of the first transmission 310 and second transmission 320 that is associated with a first capability value set over the other one that is associated with a second capability value set. The first capability value set may be higher or lower than the second capability value set.

In some example embodiments, a transmission power allocation for one of the first transmission 310 and the second transmission 320 is prioritized over the other one based on panel indexes or UL beam indications. In the above cases, the terminal device 110 may prioritize the UL transmission associated with a given capability value set (or even panel) or with a relatively lower or higher capability value set index (or panel index).

In some example embodiments, the terminal device 110 may prioritize a transmission power allocation for one of the first transmission 310 and the second transmission 320 that is associated with a given TCI state or TCI state set.

In some example embodiments, the terminal device 110 may prioritize a transmission power allocation for one of the first transmission 310 and the second transmission 320 that is associated with the TCI state or beam or reference signal or capability value set with larger or lower L1-RSRP, which may be reported by the terminal device 110 via beam reporting.

In some example embodiments, the terminal device 110 prioritizes a transmission power allocation for one of the first transmission 310 and the second transmission 320 that is associated with a first reference signal received power (RSRP) over the other one that is associated with a second RSRP. The first RSRP may be higher or lower than the second RSRP.

In some example embodiments where the first transmission 310 corresponds to a first link and the second transmission 320 corresponds to a second link, and a pathloss of the first link is higher than the second link, the terminal device 110 may prioritize a transmission power allocation for the first transmission 310 over the second transmission 320. In this case, the terminal device 110 may prioritize the UL transmission corresponding to the link or TRP or panel with the larger pathloss.

For the scenario 400, in the embodiments where the first cell 102 is the primary cell and the cell 104 is the secondary cell, the terminal device 110 assigns a higher power allocation priority to the first set of the simultaneous transmissions 410 and 420 for the primary cell than the second set of simultaneous transmissions 440 and 450 for the secondary cell.

Additionally, in some embodiments, the cell 102 is configured with the first resource set and the second resource set and the cell 104 is configured with a third resource set and a fourth resource set. The first resource set and the third resource set may be same or different resource sets. The second resource set and the fourth resource set may be same or different resource sets. The first transmission 410 corresponds to the first resource set, the second transmission 420 corresponds to the second resource set, the fourth transmission 440 corresponds to the third resource set and the fifth transmission 450 corresponds to the fourth resource set. In this case, for the primary cell, the terminal device 110 may prioritize a transmission power allocation for the first transmission 410 that corresponds to the first resource set over the second transmission 420 that corresponds to the second resource set. For the secondary cell, the terminal device 110 may prioritize a transmission power allocation for the fifth transmission 450 that corresponds to the fourth resource set over the fourth transmission 440 that corresponds to the third resource set.

In a case of single-DCI operation, the first, second, third and fourth resource sets may be SRS resource sets. In a case of multi-DCI operation, the first, second, third and fourth resource sets may be CORESETs where each set is identified by CORESET pool index.

In a case of inter-cell operation for the scenario 400, the UL transmission corresponding to a given PCI may be prioritized, where there may one PCI provided in physical cell identity and another PCI (for the so-called non-serving cell).

In some embodiments where the first set of simultaneous transmissions 410 and 420 and the second set of simultaneous transmissions 440 and 450 are associated with a same priority index, the terminal device 110 may determine the respective power allocation priorities based on contents of the first set of simultaneous transmissions 410 and 420 and the second set of simultaneous transmissions 440 and 450.

According to the example embodiments of the present disclosure, the power control scheme is provided for simultaneous UL transmissions across cells and/or within a single cell. In particular, the power control scheme enables the prioritization for transmission power allocation and/or reduction in such a way to prioritize/protect more important UL transmissions considering mainly simultaneous UL transmissions within a cell. Therefore, the performance of UL transmission operation is improved.

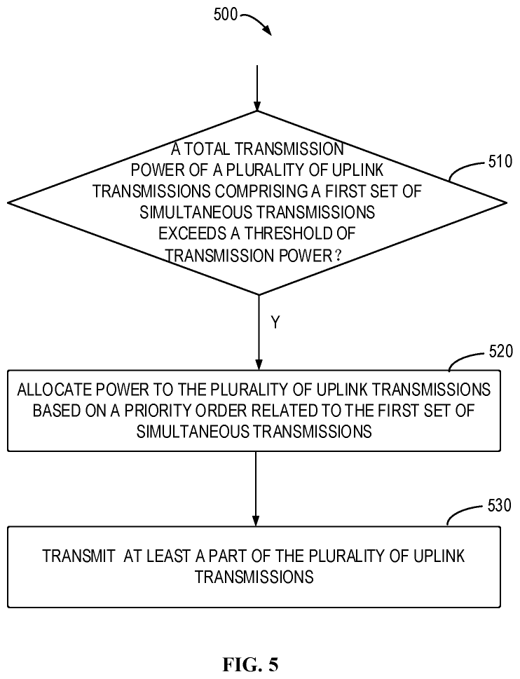

FIG. 5 illustrates a flowchart of an example method 500 according to some example embodiments of the present disclosure. The method 500 can be implemented at an apparatus, for example, the terminal device 110 described with reference to FIG. 1. For the purpose of discussion, the method 500 will be described with reference to FIG. 1.

At 510, the terminal device 110 determines whether a total transmission power of a plurality of UL transmissions comprising a first set of simultaneous transmissions exceeds a threshold of transmission power. In some embodiments, the first set of simultaneous transmissions is on a cell (e.g., the cell 102), and comprises at least a first transmission and a second transmission overlapping at least partly in time domain.

If the total transmission power of the plurality of UL transmissions exceeds the threshold of transmission power, at 520, the terminal device 110 allocates power to the plurality of UL transmissions based on a priority order related to the first set of simultaneous transmissions.

In some example embodiments, the priority order may be based at least partly on priority indexes of the plurality of the UL transmissions.

In some example embodiments, the plurality of UL transmissions may further comprise a third transmission on a different cell (e.g., the cell 104) than the first set of simultaneous transmissions, and the third transmission is overlapping with the first set of simultaneous transmissions in time domain. In these embodiments, the terminal device 110 may receive a priority index for the first set of simultaneous transmissions and a priority index for the third transmission via at least one of a RRC message, or a MAC CE or a DCI. The terminal device 110 may prioritize, based on the priority order, power allocation for the first set of simultaneous transmissions over the third transmission, in accordance with a determination that the priority index for the first set of simultaneous transmissions is larger than the priority index for the third transmission.

In some example embodiments, the plurality of UL transmissions may further comprise a third transmission on a different cell (e.g., the cell 104) than the first set of simultaneous transmissions, and the third transmission is overlapping with the first set of simultaneous transmissions in time domain. In these embodiments, the terminal device 110 may prioritize, based on the priority order, power allocation for the first set of simultaneous transmissions over the third transmission, in accordance with a determination that the first set of simultaneous transmissions and the third transmission are associated with a same priority index.

In some example embodiments, the terminal device 110 may prioritize, based on the priority order, power allocation for a PRACH transmission on a primary cell over the first set of simultaneous transmissions.

In some example embodiments, the cell 102 may be a primary cell and the plurality of UL transmissions may comprise at least one of a second set of simultaneous transmissions or the third transmission on a secondary cell, and the at least one of the second set of simultaneous transmissions or the third transmission is overlapping with the first set of simultaneous transmissions in time domain. In these embodiments, the terminal device 110 may prioritize, based on the priority order, power allocation for the first set of simultaneous transmissions over the at least one of the second set of simultaneous transmissions or the third transmission.

In some example embodiments, the terminal device 110 may prioritize, based on the priority order, power allocation for the first transmission over the second transmission, in accordance with a determination that the first transmission is associated with a higher CORESETPoolIndex than the second transmission.

Alternatively, in some other embodiments, the terminal device 110 may prioritize, based on the priority order, power allocation for the first transmission over the second transmission, in accordance with a determination that the first transmission is associated with a lower CORESETPoolIndex than the second transmission.

In some example embodiments, the terminal device 110 may receive an indication indicating a CORESETPoolIndex from the network device 120 via at least one of a RRC message, or a MAC CE or a DCI. The terminal device 110 may prioritize, based on the priority order, power allocation for the first transmission over the second transmission, in accordance with a determination that the first transmission is associated with the indicated CORESETPoolIndex.

In some example embodiments, the terminal device 110 may prioritize, based on the priority order, power allocation for the first transmission over the second transmission, in accordance with a determination that the first transmission is associated with a higher SRS resource set index than the second transmission.

Alternatively, in some other embodiments, the terminal device 110 may prioritize, based on the priority order, power allocation for the first transmission over the second transmission, in accordance with a determination that the first transmission is associated with a lower SRS resource set index than the second transmission.

In some example embodiments, the terminal device 110 may receive an indication indicating a sounding reference signal, sounding reference signal, SRS resource set index from the network device 120 via at least one of a RRC message, or a MAC CE or a DCI. The terminal device 110 may prioritize, based on the priority order, power allocation for the first transmission over the second transmission, in accordance with a determination that the first transmission is associated with the indicated SRS resource set index.

In some example embodiments, the terminal device 110 may prioritize, based on the priority order, power allocation for the first transmission over the second transmission, in accordance with a determination that the first transmission is associated with a higher physical cell identity (PCI) than the second transmission.

Alternatively, in some other embodiments, the terminal device 110 may prioritize, based on the priority order, power allocation for the first transmission over the second transmission, in accordance with a determination that the first transmission is associated with a lower physical cell identity than the second transmission.

In some example embodiments, the terminal device 110 may receive an indication indicating a physical cell identity from the network device 120 via at least one of a RRC message, or a MAC CE or a DCI. The terminal device 110 may prioritize, based on the priority order, power allocation for the first transmission over the second transmission, in accordance with a determination that the first transmission is associated with the indicated physical cell identity.

In some example embodiments, the terminal device 110 may prioritize, based on the priority order, power allocation for the first transmission over the second transmission, in accordance with a determination that the first transmission is associated with a higher capability value set index than the second transmission. In present disclosure, a capability value set index may be a UE capability value set index, or an index for a UE panel.

Alternatively, in some other embodiments, the terminal device 110 may prioritize, based on the priority order, power allocation for the first transmission over the second transmission, in accordance with a determination that the first transmission is associated with a lower capability value set index than the second transmission.

In some example embodiments, the terminal device 110 may receive an indication indicating a capability value set index from the network device 120 via at least one of a RRC message, or a MAC CE or a DCI. The terminal device 110 may prioritize, based on the priority order, power allocation for the first transmission over the second transmission, in accordance with a determination that the first transmission is associated with the indicated capability value set index.

In some example embodiments, the terminal device 110 may prioritize, based on the priority order, power allocation for the first transmission over the second transmission, in accordance with a determination that the first transmission is associated with a higher TCI state identity or TCI state set identity than the second transmission. In present disclosure, a TCI state (set) identity may be an index for a TCI state (set).

Alternatively, in some other embodiments, the terminal device 110 may prioritize, based on the priority order, power allocation for the first transmission over the second transmission, in accordance with a determination that the first transmission is associated with a lower TCI state identity or TCI state set identity than the second transmission.

In some example embodiments, the terminal device 110 may receive an indication indicating a TCI state or a TCI state set from the network device 120 via at least one of a RRC message, or a MAC CE or a DCI. The terminal device 110 may prioritize, based on the priority order, power allocation for the first transmission over the second transmission, in accordance with a determination that the first transmission is associated with the indicated TCI state or the indicated TCI state set.

In some example embodiments, the terminal device 110 may prioritize, based on the priority order, power allocation for the first transmission over the second transmission, in accordance with a determination that the first transmission is associated with a higher RSRP for a corresponding TCI state or a corresponding uplink beam or a corresponding reference signal resource set or a capability value set index or a panel index than the second transmission.

Alternatively, in some other embodiments, the terminal device 110 may prioritize, based on the priority order, power allocation for the first transmission over the second transmission, in accordance with a determination that the first transmission is associated with a lower RSRP for a corresponding TCI state or a corresponding uplink beam or a corresponding reference signal resource set or a capability value set index or a panel index than the second transmission.

In some example embodiments, the terminal device 110 may prioritize, based on the priority order, power allocation for the first transmission over the second transmission, in accordance with a determination that the first transmission is associated with a higher pathloss for a corresponding link between the terminal device 110 and the network device 120 than the second transmission.

Alternatively, in some other embodiments, the terminal device 110 may prioritize, based on the priority order, power allocation for the first transmission over the second transmission, in accordance with a determination that the first transmission is associated with a lower pathloss for a corresponding link between the terminal device 110 and the network device 120 than the second transmission.

In some example embodiments, the terminal device 110 may receive an indication indicating a closed-loop index. In these embodiments, terminal device 110 may prioritize, based on the priority order, power allocation for the first transmission over the second transmission, in accordance with a determination that the first transmission is associated with the indicated closed-loop index.

In some example embodiments, the first transmission and the second transmission each may comprise one of the following: a PUCCH transmission, a PUSCH transmission, a PRACH transmission or an SRS transmission.

In some example embodiments, the plurality of UL transmissions may further comprise a second set of simultaneous transmissions on a different cell (e.g., the cell 104) than the first set of simultaneous transmissions, and the second set of simultaneous transmissions may comprise a third transmission and a fourth transmission. In these embodiments, if the first set of simultaneous transmissions and the second set of simultaneous transmissions are associated with a same priority index, the terminal device 110 may allocate power for the first and second sets of simultaneous transmissions in the descending order:
simultaneous PUCCH transmissions with at least one of HARQ-ACK information, a scheduling request, a link recovery request, or simultaneous PUSCH transmissions with HARQ-ACK information;
simultaneous PUCCH transmissions with CSI, or simultaneous PUSCH transmissions with CSI;
simultaneous PUSCH transmissions without HARQ-ACK information or CSI, or simultaneous PUSCH transmissions on a primary cell.

At 530, the terminal device 110 transmits, to the network device 120, at least a part of the plurality of UL transmissions.

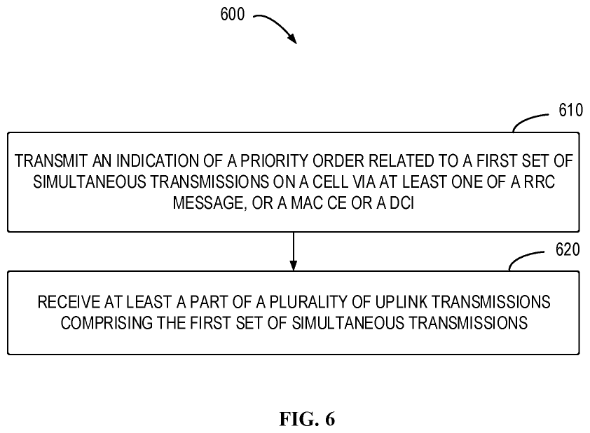

FIG. 6 illustrates a flowchart of an example method 600 according to some example embodiments of the present disclosure. The method 600 can be implemented at an apparatus, for example, the network device 120 described with reference to FIG. 1. For the purpose of discussion, the method 600 will be described with reference to FIG. 1.

At 610, the network device 120 transmits, to a terminal device 110, an indication of a priority order related to a first set of simultaneous transmissions on a cell via at least one of a RRC message, or a MAC CE or a DCI. The first set of simultaneous transmissions may comprise at least a first transmission and a second transmission overlapping at least partly in time domain.

At 620, the network device 120 receives, from the terminal device 110, at least a part of a plurality of UL transmissions comprising the first set of simultaneous transmissions. The at least a part of UL transmissions is transmitted with power allocated based on the priority order.

In some example embodiments, the indication may indicate a CORESETPoolIndex, and power allocation for one of the first transmission or the second transmission that is associated with the indicated CORESETPoolIndex is prioritized over the other one of the first transmission or the second transmission.

In some example embodiments, the indication may indicate a sounding reference signal, SRS, resource set index, and power allocation for one of the first transmission or the second transmission that is associated with the indicated SRS resource set index is prioritized over the other one of the first transmission or the second transmission.

In some example embodiments, the indication may indicate a physical cell identity, and power allocation for one of the first transmission or the second transmission that is associated with the indicated physical cell identity is prioritized over the other one of the first transmission or the second transmission.

In some example embodiments, the indication may indicate a capability value set index, and power allocation for one of the first transmission or the second transmission that is associated with the indicated capability value set index is prioritized over the other one of the first transmission or the second transmission.

In some example embodiments, the indication may indicate a transmission configuration indicator, TCI, state or a TCI state set, and power allocation for one of the first transmission or the second transmission that is associated with the indicated TCI state or the indicated TCI state set is prioritized over the other one of the first transmission or the second transmission.

In some example embodiments, the indication may indicate a closed-loop index, and power allocation for one of the first transmission or the second transmission that is associated with the indicated closed-loop index is prioritized over the other one of the first transmission or the second transmission.

In some example embodiments, an apparatus capable of performing the method 500 (for example, the terminal device 110) may comprise means for performing the respective steps of the method 500. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the apparatus.

In some example embodiments, the apparatus comprises: means for in accordance with a determination that a total transmission power of a plurality of uplink transmissions comprising a first set of simultaneous transmissions exceeds a threshold of transmission power, allocating power to the plurality of uplink transmissions based on a priority order related to the first set of simultaneous transmissions, wherein the first set of simultaneous transmissions is on a cell and comprises at least a first transmission and a second transmission overlapping at least partly in time domain; and means for transmitting, to a network device, at least a part of the plurality of uplink transmissions.

In some example embodiments, the plurality of uplink transmissions further comprises a third transmission on a different cell than the first set of simultaneous transmission, and the third transmission is overlapping with the first set of simultaneous transmissions in time domain, and the means for allocate power to the plurality of uplink transmissions comprises: means for receiving a priority index for the first set of simultaneous transmissions and a priority index for the third transmission via at least one of a radio resource control, RRC, message, or a medium access control control element, MAC CE or a downlink control information, DCI; and means for prioritizing power allocation based on the priority order for the first set of simultaneous transmissions over the third transmission, in accordance with a determination that the priority index for the first set of simultaneous transmissions is larger than the priority index for the third transmission.

In some example embodiments, the plurality of uplink transmissions further comprises a third transmission on a different cell than the first set of simultaneous transmissions, and the third transmission is overlapping with the first set of simultaneous transmissions in time domain, and the means for allocate power to the plurality of uplink transmissions comprises: means for prioritizing, based on the priority order, power allocation for the first set of simultaneous transmissions over the third transmission, in accordance with a determination that the first set of simultaneous transmissions and the third transmission are associated with a same priority index.

In some example embodiments, the means for allocate power to the plurality of uplink transmissions comprises: means for prioritizing, based on the priority order, power allocation for a physical random access channel, PRACH, transmission on a primary cell over the first set of simultaneous transmissions.

In some example embodiments, the cell is a primary cell and the plurality of uplink transmissions comprises at least one of a second set of simultaneous transmissions or the third transmission on a secondary cell, and the at least one of the second set of simultaneous transmissions or the third transmission is overlapping with the first set of simultaneous transmissions in time domain, and the means for allocate power to the plurality of uplink transmissions comprises: means for prioritizing, based on the priority order, power allocation for the first set of simultaneous transmissions over the at least one of the second set of simultaneous transmissions or the third transmission.

In some example embodiments, the means for allocate power to the plurality of uplink transmissions comprises: means for prioritizing, based on the priority order, power allocation for the first transmission over the second transmission, in accordance with a determination that the first transmission is associated with a higher CORESETPoolIndex than the second transmission; or means for prioritizing, based on the priority order, power allocation for the first transmission over the second transmission, in accordance with a determination that the first transmission is associated with a lower CORESETPoolIndex than the second transmission.

In some example embodiments, the means for allocate power to the plurality of uplink transmissions comprises: means for receiving an indication indicating a CORESETPoolIndex from the network device via at least one of a radio resource control, RRC, message, or a medium access control control element, MAC CE or a downlink control information, DCI; and means for prioritizing, based on the priority order, power allocation for the first transmission over the second transmission, in accordance with a determination that the first transmission is associated with the indicated CORESETPoolIndex.

In some example embodiments, the means for allocate power to the plurality of uplink transmissions comprises: means for prioritizing, based on the priority order, power allocation for the first transmission over the second transmission, in accordance with a determination that the first transmission is associated with a higher sounding reference signal, SRS, resource set index than the second transmission; or means for prioritizing, based on the priority order, power allocation for the first transmission over the second transmission, in accordance with a determination that the first transmission is associated with a lower sounding reference signal, SRS, resource set index than the second transmission.

In some example embodiments, the means for allocate power to the plurality of uplink transmissions comprises: means for receiving an indication indicating a sounding reference signal, SRS resource set index from the network device via at least one of a radio resource control, RRC, message, or a medium access control control element, MAC CE or a downlink control information, DCI; and means for prioritizing, based on the priority order, power allocation for the first transmission over the second transmission, in accordance with a determination that the first transmission is associated with the indicated SRS resource set index.

In some example embodiments, the means for allocate power to the plurality of uplink transmissions comprises: means for prioritizing, based on the priority order, power allocation for the first transmission over the second transmission, in accordance with a determination that the first transmission is associated with a higher physical cell identity than the second transmission; or means for prioritizing, based on the priority order, power allocation for the first transmission over the second transmission, in accordance with a determination that the first transmission is associated with a lower physical cell identity than the second transmission.

In some example embodiments, the means for allocate power to the plurality of uplink transmissions comprises: means for receiving an indication indicating a physical cell identity from the network device via at least one of a radio resource control, RRC, message, or a medium access control control element, MAC CE or a downlink control information, DCI; and means for prioritizing, based on the priority order, power allocation for the first transmission over the second transmission, in accordance with a determination that the first transmission is associated with the indicated physical cell identity.

In some example embodiments, the means for allocate power to the plurality of uplink transmissions comprises: means for prioritizing, based on the priority order, power allocation for the first transmission over the second transmission, in accordance with a determination that the first transmission is associated with a higher capability value set index than the second transmission; or means for prioritizing, based on the priority order, power allocation for the first transmission over the second transmission, in accordance with a determination that the first transmission is associated with a lower capability value set index than the second transmission.

In some example embodiments, the means for allocate power to the plurality of uplink transmissions comprises: means for receiving an indication indicating a capability value set index from the network device via at least one of a radio resource control, RRC, message, or a medium access control control element, MAC CE or a downlink control information, DCI; and means for prioritizing, based on the priority order, power allocation for the first transmission over the second transmission, in accordance with a determination that the first transmission is associated with the indicated capability value set index.

In some example embodiments, the means for allocate power to the plurality of uplink transmissions comprises: means for prioritizing, based on the priority order, power allocation for the first transmission over the second transmission, in accordance with a determination that the first transmission is associated with a higher transmission configuration indicator, TCI, state identity or TCI state set identity than the second transmission; or means for prioritizing, based on the priority order, power allocation for the first transmission over the second transmission, in accordance with a determination that the first transmission is associated with a lower TCI state identity or TCI state set identity than the second transmission.

In some example embodiments, the means for allocate power to the plurality of uplink transmissions comprises: means for receiving an indication indicating a TCI state or a TCI state set from the network device via at least one of a radio resource control, RRC, message, or a medium access control control element, MAC CE or a downlink control information, DCI; and means for prioritizing, based on the priority order, power allocation for the first transmission over the second transmission, in accordance with a determination that the first transmission is associated with the indicated TCI state or the indicated TCI state set.

In some example embodiments, the means for allocate power to the plurality of uplink transmissions comprises: means for prioritizing, based on the priority order, power allocation for the first transmission over the second transmission, in accordance with a determination that the first transmission is associated with a higher reference signal received power, RSRP, for a corresponding TCI state or a corresponding uplink beam or a corresponding reference signal resource set or a capability value set index or a panel index than the second transmission; or means for prioritizing, based on the priority order, power allocation for the first transmission over the second transmission, in accordance with a determination that the first transmission is associated with a lower RSRP for a corresponding TCI state or a corresponding uplink beam or a corresponding reference signal resource set or a capability value set index or a panel index than the second transmission.

In some example embodiments, the means for allocate power to the plurality of uplink transmissions comprises: means for prioritizing, based on the priority order, power allocation for the first transmission over the second transmission, in accordance with a determination that the first transmission is associated with a higher pathloss for a corresponding link between the apparatus and the network device than the second transmission; or means for prioritizing, based on the priority order, power allocation for the first transmission over the second transmission, in accordance with a determination that the first transmission is associated with a lower pathloss for a corresponding link between the apparatus and the network device than the second transmission.

In some example embodiments, means for allocate power to the plurality of uplink transmissions comprises: means for receiving an indication indicating a closed-loop index; and means for prioritizing, based on the priority order, power allocation for the first transmission over the second transmission, in accordance with a determination that the first transmission is associated with the indicated closed-loop index.

In some example embodiments, the first transmission and the second transmission each comprises one of the following: a Physical Uplink Control Channel, PUCCH, transmission, a Physical Uplink Shared Channel, PUSCH, transmission, a Physical Random-Access Channel, PRACH, transmission, or a sounding reference signal, SRS, transmission.

In some example embodiments, the plurality of uplink transmissions further comprises a second set of simultaneous transmissions on a different cell than the first set of simultaneous transmissions, and the second set of simultaneous transmissions comprises a third transmission and a fourth transmission, and the means for allocating power to the plurality of uplink transmissions comprises: means for in accordance with a determination that the first set of simultaneous transmissions and the second set of simultaneous transmissions are associated with a same priority index, allocate power for the first and second sets of simultaneous transmissions in the descending order:
simultaneous PUCCH transmissions with at least one of HARQ-ACK information, a scheduling request, a link recovery request, or simultaneous PUSCH transmissions with HARQ-ACK information;
simultaneous PUCCH transmissions with CSI, or simultaneous PUSCH transmissions with CSI;
simultaneous PUSCH transmissions without HARQ-ACK information or CSI, or simultaneous PUSCH transmissions on a primary cell.

In some example embodiments, an apparatus capable of performing the method 600 (for example, the network device 120) may comprise means for performing the respective steps of the method 600. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the apparatus.

In some example embodiments, the apparatus comprises: means for transmitting, to a terminal device, an indication of a priority order related to a first set of simultaneous transmissions on a cell via at least one of a radio resource control, RRC, message, or a medium access control control element, MAC CE or a downlink control information, DCI, wherein the first set of simultaneous transmissions comprises at least a first transmission and a second transmission overlapping at least partly in time domain; and means for receiving, from the terminal device, at least a part of a plurality of uplink transmissions comprising the first set of simultaneous transmissions, the at least a part of uplink transmissions being transmitted with power allocated based on the priority order.

In some example embodiments, the indication indicates a CORESETPoolIndex, and power allocation for one of the first transmission or the second transmission that is associated with the indicated CORESETPoolIndex is prioritized over the other one of the first transmission or the second transmission.

In some example embodiments, the indication indicates a sounding reference signal, SRS, resource set index, and power allocation for one of the first transmission or the second transmission that is associated with the indicated SRS resource set index is prioritized over the other one of the first transmission or the second transmission.

In some example embodiments, the indication indicates a physical cell identity, and power allocation for one of the first transmission or the second transmission that is associated with the indicated physical cell identity is prioritized over the other one of the first transmission or the second transmission.

In some example embodiments, the indication indicates a capability value set index, and power allocation for one of the first transmission or the second transmission that is associated with the indicated capability value set index is prioritized over the other one of the first transmission or the second transmission.

In some example embodiments, the indication indicates a transmission configuration indicator, TCI, state or a TCI state set, and power allocation for one of the first transmission or the second transmission that is associated with the indicated TCI state or the indicated TCI state set is prioritized over the other one of the first transmission or the second transmission.

In some example embodiments, the indication indicates a closed-loop index, and power allocation for one of the first transmission or the second transmission that is associated with the indicated closed-loop index is prioritized over the other one of the first transmission or the second transmission.

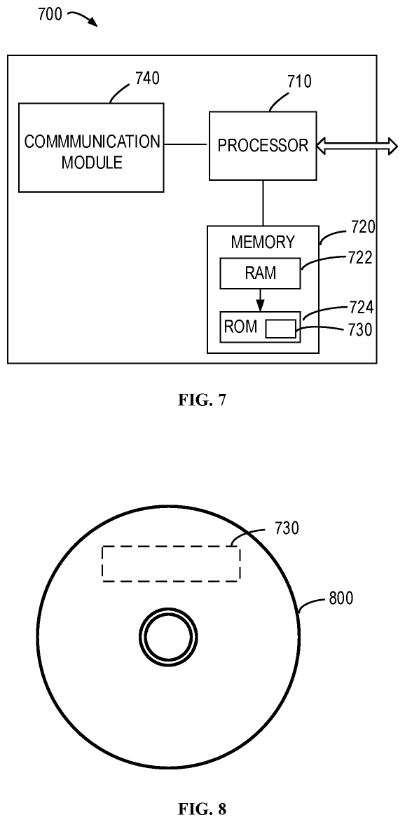

FIG. 7 is a simplified block diagram of a device 700 that is suitable for implementing embodiments of the present disclosure. The device 700 may be provided to implement the communication device, for example the terminal device 110 or the network device 120 as shown in FIG. 1. As shown, the device 700 includes one or more processors 710, one or more memories 720 coupled to the processor 710, and one or more transmitters and/or receivers (TX/RX) 740 (i.e., the communication module 740) coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2-6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIGS. 5 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-33. (canceled)

34. An apparatus, comprising:
at least one processor; and
at least one memory including computer program codes;
the at least one memory and the computer program codes are configured to, with the at least one processor, cause the apparatus at least to:
in accordance with a determination that a total transmission power of a plurality of uplink transmissions comprising a first set of simultaneous transmissions exceeds a threshold of transmission power, allocate power to the plurality of uplink transmissions based on a priority order related to the first set of simultaneous transmissions, wherein the first set of simultaneous transmissions is on a cell and comprises at least a first transmission and a second transmission overlapping at least partly in time domain; and
transmit, to a network device, at least a part of the plurality of uplink transmissions.

35. The apparatus of claim 34, wherein the plurality of uplink transmissions further comprises a third transmission on a different cell than the first set of simultaneous transmissions, and the third transmission is overlapping with the first set of simultaneous transmissions in time domain, and
wherein the at least one memory and the computer program codes are configured to, with the at least one processor, when allocating power to the plurality of uplink transmissions, cause the apparatus to allocate power to the plurality of uplink transmissions by:
receiving a priority index for the first set of simultaneous transmissions and a priority index for the third transmission via at least one of a radio resource control, RRC, message, or a medium access control control element, MAC CE or a downlink control information, DCI; and
prioritizing, based on the priority order, power allocation for the first set of simultaneous transmissions over the third transmission, in accordance with a determination that the priority index for the first set of simultaneous transmissions is larger than the priority index for the third transmission.

36. The apparatus of claim 34, wherein the plurality of uplink transmissions further comprises a third transmission on a different cell than the first set of simultaneous transmissions, and the third transmission is overlapping with the first set of simultaneous transmissions in time domain, and
wherein the at least one memory and the computer program codes are configured to, with the at least one processor, when allocating power to the plurality of uplink transmissions, cause the apparatus to allocate power to the plurality of uplink transmissions by:
prioritizing, based on the priority order, power allocation for the first set of simultaneous transmissions over the third transmission, in accordance with a determination that the first set of simultaneous transmissions and the third transmission are associated with a same priority index.

37. The apparatus of claim 34, wherein the at least one memory and the computer program codes are configured to, with the at least one processor, when allocating power to the plurality of uplink transmissions, cause the apparatus to allocate power to the plurality of uplink transmissions by:
prioritizing, based on the priority order, power allocation for a physical random access channel, PRACH, transmission on a primary cell over the first set of simultaneous transmissions.

38. The apparatus of claim 34, wherein the cell is a primary cell and the plurality of uplink transmissions further comprises at least one of a second set of simultaneous transmissions or a third transmission on a secondary cell, and the at least one of the second set of simultaneous transmissions or the third transmission is overlapping with the first set of simultaneous transmissions in time domain, and
wherein the at least one memory and the computer program codes are configured to, with the at least one processor, when allocating power to the plurality of uplink transmissions, cause the apparatus to allocate power to the plurality of uplink transmissions by:
prioritizing, based on the priority order, power allocation for the first set of simultaneous transmissions over the at least one of the second set of simultaneous transmissions or the third transmission.

39. The apparatus of claim 34, wherein the at least one memory and the computer program codes are configured to, with the at least one processor, when allocating power to the plurality of uplink transmissions, cause the apparatus to allocate power to the plurality of uplink transmissions by one of the following:
prioritizing, based on the priority order, power allocation for the first transmission over the second transmission, in accordance with a determination that the first transmission is associated with a higher CORESETPoolIndex than the second transmission;
prioritizing, based on the priority order, power allocation for the first transmission over the second transmission, in accordance with a determination that the first transmission is associated with a lower CORESETPoolIndex than the second transmission;
prioritizing, based on the priority order, power allocation for the first transmission over the second transmission, in accordance with a determination that the first transmission is associated with a higher sounding reference signal, SRS, resource set index than the second transmission;
prioritizing, based on the priority order, power allocation for the first transmission over the second transmission, in accordance with a determination that the first transmission is associated with a lower SRS resource set index than the second transmission;
prioritizing, based on the priority order, power allocation for the first transmission over the second transmission, in accordance with a determination that the first transmission is associated with a higher physical cell identity than the second transmission;
prioritizing, based on the priority order, power allocation for the first transmission over the second transmission, in accordance with a determination that the first transmission is associated with a lower physical cell identity than the second transmission;
prioritizing, based on the priority order, power allocation for the first transmission over the second transmission, in accordance with a determination that the first transmission is associated with a higher capability value set index than the second transmission;
prioritizing, based on the priority order, power allocation for the first transmission over the second transmission, in accordance with a determination that the first transmission is associated with a lower capability value set index than the second transmission;
prioritizing, based on the priority order, power allocation for the first transmission over the second transmission, in accordance with a determination that the first transmission is associated with a higher transmission configuration indicator, TCI, state identity or TCI state set identity than the second transmission;
prioritizing, based on the priority order, power allocation for the first transmission over the second transmission, in accordance with a determination that the first transmission is associated with a lower TCI state identity or TCI state set identity than the second transmission;
prioritizing, based on the priority order, power allocation for the first transmission over the second transmission, in accordance with a determination that the first transmission is associated with a higher reference signal received power, RSRP, for a corresponding TCI state or a corresponding uplink beam or a corresponding reference signal resource set or a capability value set index or a panel index than the second transmission;
prioritizing, based on the priority order, power allocation for the first transmission over the second transmission, in accordance with a determination that the first transmission is associated with a lower RSRP for a corresponding TCI state or a corresponding uplink beam or a corresponding reference signal resource set or a capability value set index or a panel index than the second transmission;
prioritizing, based on the priority order, power allocation for the first transmission over the second transmission, in accordance with a determination that the first transmission is associated with a higher pathloss for a corresponding link between the apparatus and the network device than the second transmission; or
prioritizing, based on the priority order, power allocation for the first transmission over the second transmission, in accordance with a determination that the first transmission is associated with a lower pathloss for a corresponding link between the apparatus and the network device than the second transmission.

40. The apparatus of claim 34, wherein the at least one memory and the computer program codes are configured to, with the at least one processor, when allocating power to the plurality of uplink transmissions, cause the apparatus to allocate power to the plurality of uplink transmissions by:
receiving an indication indicating at least one of a CORESETPoolIndex, an SRS resource set index, a physical cell identity, a capability value set index, a TCI state or a TCI state set, or a closed-loop index, from the network device via at least one of a RRC message, or a MAC CE or a DCI; and
prioritizing, based on the priority order, power allocation for the first transmission over the second transmission, in accordance with a determination that the first transmission is associated with the at least one of indicated CORESETPoolIndex, SRS resource set index, physical cell identity, capability value set index, TCI state or TCI state set, or closed-loop index.

41. The apparatus of claim 34, wherein the first transmission and the second transmission each comprises one of the following:
a Physical Uplink Control Channel, PUCCH, transmission, or
a Physical Uplink Shared Channel, PUSCH, transmission, or
a PRACH transmission, or
a SRS transmission.

42. The apparatus of claim 34, wherein the plurality of uplink transmissions further comprises a second set of simultaneous transmissions on a different cell than the first set of simultaneous transmissions, and
wherein the at least one memory and the computer program codes are configured to, with the at least one processor, when allocating power to the plurality of uplink transmissions, cause the apparatus to allocate power to the plurality of uplink transmissions by:
in accordance with a determination that the first set of simultaneous transmissions and the second set of simultaneous transmissions are associated with a same priority index, allocate power for the first and second sets of simultaneous transmissions in the descending order:
simultaneous PUCCH transmissions with at least one of HARQ-ACK information or a scheduling request or a link recovery request, or simultaneous PUSCH transmissions with HARQ-ACK information;
simultaneous PUCCH transmissions with a CSI, or simultaneous PUSCH transmissions with a CSI;
simultaneous PUSCH transmissions without HARQ-ACK information or CSI, or simultaneous PUSCH transmission on a primary cell.

43. An apparatus, comprising:
at least one processor; and
at least one memory including computer program codes;
the at least one memory and the computer program codes are configured to, with the at least one processor, cause the apparatus at least to:
transmit, to a terminal device, an indication of a priority order related to a first set of simultaneous transmissions on a cell via at least one of a radio resource control, RRC, message, or a medium access control control element, MAC CE or a downlink control information, DCI, wherein the first set of simultaneous transmissions comprises at least a first transmission and a second transmission overlapping at least partly in time domain; and
receive, from the terminal device, at least a part of a plurality of uplink transmissions comprising the first set of simultaneous transmissions, the at least a part of uplink transmissions being transmitted with power allocated based on the priority order.

44. The apparatus of claim 43, wherein the indication indicates at least one of a CORESETPoolIndex, an SRS resource set index, a physical cell identity, a capability value set index, a TCI state or a TCI state set, or a closed-loop index, and power allocation for one of the first transmission or the second transmission that is associated with the at least one of indicated CORESETPoolIndex, SRS resource set index, physical cell identity, capability value set index, TCI state or TCI state set, or closed-loop index, is prioritized over the other one of the first transmission or the second transmission.

45. A method, comprising:
in accordance with a determination that a total transmission power of a plurality of uplink transmissions comprising a first set of simultaneous transmissions exceeds a threshold of transmission power, allocating, at a terminal device, power to the plurality of uplink transmissions based on a priority order related to the first set of simultaneous transmissions, wherein the first set of simultaneous transmissions is on a cell and comprises at least a first transmission and a second transmission overlapping at least partly in time domain; and
transmitting, to a network device, at least a part of the plurality of uplink transmissions.

46. The method of claim 45, wherein the plurality of uplink transmissions further comprises a third transmission on a different cell than the first set of simultaneous transmissions, and the third transmission is overlapping with the first set of simultaneous transmissions in time domain, and
wherein the allocating power to the plurality of uplink transmissions comprises:
receiving a priority index for the first set of simultaneous transmissions and a priority index for the third transmission via at least one of a radio resource control, RRC, message, or a medium access control control element, MAC CE or a downlink control information, DCI; and
prioritizing, based on the priority order, power allocation for the first set of simultaneous transmissions over the third transmission, in accordance with a determination that the priority index for the first set of simultaneous transmissions is larger than the priority index for the third transmission.

47. The method of claim 45, wherein the plurality of uplink transmissions further comprises a third transmission on a different cell than the first set of simultaneous transmissions, and the third transmission is overlapping with the first set of simultaneous transmissions in time domain, and
wherein the allocating power to the plurality of uplink transmissions comprises:
prioritizing, based on the priority order, power allocation for the first set of simultaneous transmissions over the third transmission, in accordance with a determination that the first set of simultaneous transmissions and the third transmission are associated with a same priority index.

48. The method of claim 45, wherein the allocating power to the plurality of uplink transmissions comprises:
prioritizing, based on the priority order, power allocation for a physical random access channel, PRACH, transmission on a primary cell over the first set of simultaneous transmissions.

49. The method of claim 45, wherein the cell is a primary cell and the plurality of uplink transmissions further comprises at least one of a second set of simultaneous transmissions or a third transmission on a secondary cell, and the at least one of the second set of simultaneous transmissions or the third transmission is overlapping with the first set of simultaneous transmissions in time domain, and
wherein the allocating power to the plurality of uplink transmissions comprises:
prioritizing, based on the priority order, power allocation for the first set of simultaneous transmissions over the at least one of the second set of simultaneous transmissions or the third transmission.

50. The method of claim 45, wherein the allocating power to the plurality of uplink transmissions comprises one of the following:
prioritizing, based on the priority order, power allocation for the first transmission over the second transmission, in accordance with a determination that the first transmission is associated with a higher CORESETPoolIndex than the second transmission;
prioritizing, based on the priority order, power allocation for the first transmission over the second transmission, in accordance with a determination that the first transmission is associated with a lower CORESETPoolIndex than the second transmission;
prioritizing, based on the priority order, power allocation for the first transmission over the second transmission, in accordance with a determination that the first transmission is associated with a higher sounding reference signal, SRS, resource set index than the second transmission;
prioritizing, based on the priority order, power allocation for the first transmission over the second transmission, in accordance with a determination that the first transmission is associated with a lower SRS resource set index than the second transmission;
prioritizing, based on the priority order, power allocation for the first transmission over the second transmission, in accordance with a determination that the first transmission is associated with a higher physical cell identity than the second transmission;
prioritizing, based on the priority order, power allocation for the first transmission over the second transmission, in accordance with a determination that the first transmission is associated with a lower physical cell identity than the second transmission;
prioritizing, based on the priority order, power allocation for the first transmission over the second transmission, in accordance with a determination that the first transmission is associated with a higher capability value set index than the second transmission;
prioritizing, based on the priority order, power allocation for the first transmission over the second transmission, in accordance with a determination that the first transmission is associated with a lower capability value set index than the second transmission;
prioritizing, based on the priority order, power allocation for the first transmission over the second transmission, in accordance with a determination that the first transmission is associated with a higher transmission configuration indicator, TCI, state identity or TCI state set identity than the second transmission;
prioritizing, based on the priority order, power allocation for the first transmission over the second transmission, in accordance with a determination that the first transmission is associated with a lower TCI state identity or TCI state set identity than the second transmission;
prioritizing, based on the priority order, power allocation for the first transmission over the second transmission, in accordance with a determination that the first transmission is associated with a higher reference signal received power, RSRP, for a corresponding TCI state or a corresponding uplink beam or a corresponding reference signal resource set or a capability value set index or a panel index than the second transmission;
prioritizing, based on the priority order, power allocation for the first transmission over the second transmission, in accordance with a determination that the first transmission is associated with a lower RSRP for a corresponding TCI state or a corresponding uplink beam or a corresponding reference signal resource set or a capability value set index or a panel index than the second transmission;
prioritizing, based on the priority order, power allocation for the first transmission over the second transmission, in accordance with a determination that the first transmission is associated with a higher pathloss for a corresponding link between the apparatus and the network device than the second transmission; or
prioritizing, based on the priority order, power allocation for the first transmission over the second transmission, in accordance with a determination that the first transmission is associated with a lower pathloss for a corresponding link between the apparatus and the network device than the second transmission.

51. The apparatus of claim 45, wherein the allocating power to the plurality of uplink transmissions comprises:
receiving an indication indicating at least one of a CORESETPoolIndex, an SRS resource set index, a physical cell identity, a capability value set index, a TCI state or a TCI state set, or a closed-loop index, from the network device via at least one of a RRC message, or a MAC CE or a DCI; and
prioritizing, based on the priority order, power allocation for the first transmission over the second transmission, in accordance with a determination that the first transmission is associated with the at least one of indicated CORESETPoolIndex, SRS resource set index, physical cell identity, capability value set index, TCI state or TCI state set, or closed-loop index.

52. The apparatus of claim 45, wherein the first transmission and the second transmission each comprises one of the following:
a Physical Uplink Control Channel, PUCCH, transmission, or
a Physical Uplink Shared Channel, PUSCH, transmission, or
a PRACH transmission, or
a SRS transmission.

53. The method of claim 45, wherein the plurality of uplink transmissions further comprises a second set of simultaneous transmissions on a different cell than the first set of simultaneous transmissions, and
wherein the allocating power to the plurality of uplink transmissions comprises:
in accordance with a determination that the first set of simultaneous transmissions and the second set of simultaneous transmissions are associated with a same priority index, allocating power for the first and second sets of simultaneous transmissions in the descending order:
simultaneous PUCCH transmissions with at least one of HARQ-ACK information or a scheduling request or a link recovery request, or simultaneous PUSCH transmissions with HARQ-ACK information;
simultaneous PUCCH transmissions with a CSI, or simultaneous PUSCH transmissions with a CSI;
simultaneous PUSCH transmissions without HARQ-ACK information or CSI, or simultaneous PUSCH transmission on a primary cell.
